(19) United States
(12) Patent Application Publication
(10) Pub. No.: US 2021/0206969 A1
(43) Pub. Date: Jul. 8, 2021

(54) MATERIAL COMPOSITION AND PROCESS FOR PREPARATION THEREOF

(71) Applicant: YUK KIN WONG, Hong Kong (HK)

(72) Inventor: YUK KIN WONG, Hong Kong (HK)

(21) Appl. No.: 17/128,160

(22) Filed: Dec. 20, 2020

(30) Foreign Application Priority Data
Jan. 8, 2020 (HK) 32020001119.7

(51) Int. Cl. C08L 77/02

(52) U.S. Cl. CPC C08L 77/02; C08L 29/04; C08L 2312/00

(57) ABSTRACT

The present disclosure provides a material composition, comprising: i) hydroxyl-termination polymer cross-linked by a boron compound; and ii) thermoplastic. The present disclosure also provides a method of producing the material composition. The material composition of the present invention comprises hydroxyl-termination polymer cross-linked by a boron compound which can make the material stretchable and non-sticky. Then thermoplastic was used to improve the stretch ability and make it easy for moulding.

### CROSS-REFERENCE TO RELATED APPLICATIONS

This application claims priority to HONG KONG Patent Application No. 32020001119.7 with a filing date of Jan. 8, 2020. The content of the aforementioned applications, including any intervening amendments thereto, are incorporated herein by reference.

### TECHNICAL FIELD

The present disclosure relates to the field of class play and modeling materials, and more particularly to a material composition and a process for preparation thereof.

### BACKGROUND

Class play and modeling materials are such as playdoh, silly putty, super light clay etc. The inventions are used for toys over 30 years. However, playdoh has bad smell and contain preservative which can linger on hand as it is sticky, meanwhile it is not easy to hold shape. Silly putty is “melt” and not easy for moulding. Super light clay is shrunk after dried as the water content is over 40%.

### SUMMARY OF THE DISCLOSURE

Based on this, it is necessary to provide a non-sticky and stretchable material composition which is easy for moulding.

A material composition, comprising: i) hydroxyl-termination polymer cross-linked by a boron compound; and ii) thermoplastic having melting point below 100° C.

In one of the embodiments, the thermoplastic is polycaprolactone (Cas number:24980-41-4).

In one of the embodiments, a weight ratio of thermoplastic to the material composition is 1-60%.

In one of the embodiments, a weight ratio of thermoplastic to the material composition is 5-60%.

In one of the embodiments, the material composition further comprising 1-10% weight percent density reducing filter.

In one of the embodiments, the material composition is water soluble, and a weight ratio of boron to the material composition is less than 0.1%.

In one of the embodiments, wherein the material composition is oil soluble, and a weight ratio of boron to the material composition is 0.6-0.8%.

A method of producing the above material composition, comprising: supplying component i) hydroxyl-termination polymer cross-linked by a boron compound and component ii) thermoplastic to the mixer; mixing component i) and component ii) to get the mixture.

In one of the embodiments, the method further comprising: adding density reducing filter into the mixer and mixing it with the mixture at room temperature.

The material composition of the present invention comprises hydroxyl-termination polymer cross-linked by a boron compound which can make the material stretchable and non-sticky. Then thermoplastic was used to improve the stretch ability and make it easy for moulding.

### BRIEF DESCRIPTION OF THE DRAWING

FIG. 1 is a process flow chart of the method of producing the material composition in one embodiment.

FIG. 2 is a process flow chart of the method of producing the material composition in another embodiment.

### DETAILED DESCRIPTION OF THE EMBODIMENTS

For the purpose of understanding the present invention, the present disclosure will be described in detail hereinafter with reference to the accompanying drawings. The preferred embodiments of the present disclosure are given in the accompanying drawings. However, the disclosure may be implemented in many different forms and is not limited to the embodiments described herein. On the contrary, the purpose of providing these embodiments is to facilitate thorough understanding of the present disclosure.

Unless otherwise defined, all technical and scientific terms used herein have the same meaning as commonly understood by those skilled in the relevant art of the present disclosure. The terminology used herein in the specification of the present disclosure is for the purpose of describing specific embodiments only and is not intended to limit the invention. The term “and/or” as used herein includes any and all combinations of one or more of the associated listed items.

A material composition of the present invention, comprising: i) hydroxyl-termination polymer cross-linked by a boron compound; and ii) thermoplastic having melting point below 100° C.

Hydroxyl-termination polymer reacted with boron in high temperature to form a cross-linked compound that is hydroxyl-termination polymer cross-linked by a boron compound. hydroxyl-termination polymer cross-linked by a boron compound existed in the flexible material for kneading (such as silly putty, super light clay etc.), this kind of material can be directly used as component of the material composition of the present invention. Hydroxyl-termination polymer cross-linked by a boron compound can make the material composition stretchable and non-sticky.

In a preferred embodiment, hydroxyl-termination polymer is at least one of Polyvinyl alcohol (PVA) and hydroxyl-termination silicone oil. Wherein, PVA is used for water soluble material composition; hydroxyl-termination silicone oil is used for oil soluble material composition.

In order to improve the stretch ability of the material composition and make it easy for moulding, thermoplastic was added, thus the material composition tend to stay together and compound hold their shape for long time after moulding. It is to be understood that the thermoplastics are low-melting plastics. In this context, preferably, the thermoplastics are low-melting plastics with a melting point of less than 100° C. to facilitate the shaping of the material composition. It is conceivable that all low melting point plastics can be used in this disclosure. More preferably, the thermoplastic is polycaprolactone (Cas number:24980-41-4, melting point between 40-60C).

In a preferred embodiment, a weight ratio of thermoplastic to the material to composition is 1-60%. More preferably, a weight ratio of thermoplastic to the material composition is 5-60%. The addition of thermoplastic improves the elongation performance of the material composition. Thanks to the improvement in elongation performance, the material composition tends to be held together more easily and can maintain its shape for a long time after being shaped.

In order to prevent the material composition “melting” and returning to its original viscosity after a period of time, so density reducing filter was added. However, high content of density reducing filter will make the material composition unstable, harstretchable and it is difficult for modeling. In a preferred embodiment, the material composition further comprising 1-10% weight percent density reducing filter.

For health and safety reasons, the ratio of boron can not be too much, however, if the material composition does not have thermoplastic, a lot of boron is needed. The material composition has less boron due to the addition of thermoplastic. In a preferred embodiment, if the material composition is water soluble, a weight ratio of boron to the material composition is less than 0.1%, for example, it could be 0.07-0.09%; if the material composition is oil soluble, and a weight ratio of boron to the material composition is 0.6-0.8% and soluble boron is less than 1200 ppm.

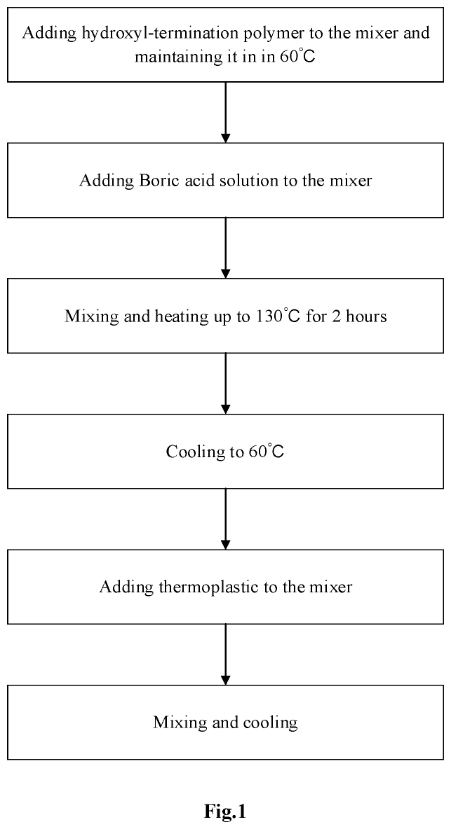

As shown in FIG. 1, it is a process flow chart of the method of producing the material composition in one embodiment. The method of producing the material composition, comprising:

1) adding hydroxyl-termination polymer to the mixer and maintaining it in 60° C.;
2) adding Boric acid in solution to the mixer;
3) mixing and heating up to 130° C. for 2 hours;
4) cooling to 60° C.;
5) adding thermoplastic to the mixer;
6) mixing and cooling.

In a preferred embodiment, between step 5) and 6), the method further comprising: adding density reduce filler before final mixing.

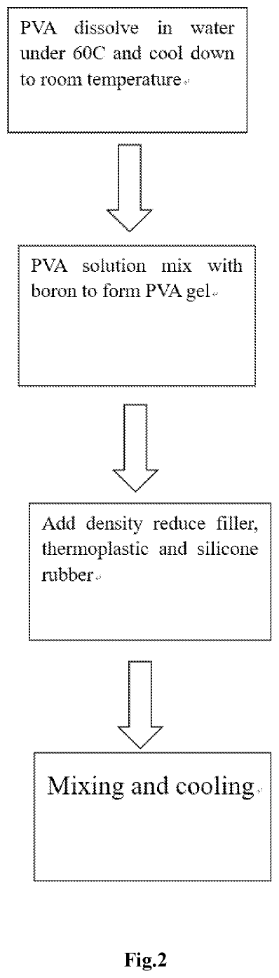

As shown in FIG. 2, it is a process flow chart of the method of producing the material composition in another embodiment. The method of producing the material composition, comprising:

1) dissolving PVA in water under 60° C. and cooling down to room temperature;
2) mixing PVA solution with boron to form PVA gel;
3) adding density reduce filler, thermoplastic;
4) mixing and cooling.

Now the invention is illustrated with specific embodiments.

The material composition includes two forms being called as thermoplastic moulding clay 1 (oil soluble/never dry) and thermoplastic moulding clay 2 (water soluble/air dry) hereinafter.

First, we compared super light clay and thermoplastic moulding clay 2 (water soluble) of the present invention as follows:

A) Ingredient wt % of super light clay
1) 2-4% density reduce filler;

### 2) PVA 7-10%;

### 3) Water 40-50%;

4) Boron content 0.5-0.9% (SVHC);

### 5) Others.

Wherein, the “others” in A is glycerin and corn flour. In some embodiments, it may be 1-20 wt % glycerin and 1-20 wt % corn flour.B) Ingredient wt % of thermoplastic moulding clay 2 (water soluble)

1) 4-6% density reduce filler;

### 2) PVA 7-10%;

### 3) Water 20-30%;

### 4) Thermoplastic 40-50%;

5) Boron content 0.07-0.09% (less than 0.1% to meet the SVHC regulation);

### 6) Others.

Wherein, the “others” in B is glycerin and corn flour. In some embodiments, it may be 1-20 wt % glycerin and 1-20 wt % corn flour.Advantages for thermoplastic moulding clay 2 (water soluble) are as follows:

1) Dry rate: As the water content was reduced (reduce 50%), the dry rate is faster (half of drying time). Super light clay needs two day in air dry, however, thermoplastic moulding clay 2 (water soluble) need one day only.
2) shrink % was reduced from 40% to 20% because of low water content. Super light is clay was shrunken for 40% after dried, however, thermoplastic moulding clay 2 (water soluble) was shrink for less than 20% after dried.
3) Boron content was reduced from 0.5% to less than 0.1%. Boron is a SVHC and ban by EU and should be under 0.1%.

Boron play an important role in formulation to stabilize the whole system. For thermoplastic moulding clay 2 (water soluble), 0.1% boron is enough to stabilize.

4) Low density for thermoplastic moulding clay 2 (water soluble) can be formed. Too high % of density reduce filler will increase the hardness for final product. Thermoplastic can reduce the hardness so that the final product of thermoplastic moulding clay 2 (water soluble) is low density than normal super clay.

Then, we compared silly putty, low density putty and thermoplastic moulding clay 1 (oil soluble) of the present invention as follows:

C) Ingredient wt % of silly putty
1) silicone oil 80-95%;
2) Boron content 1.5-5% (soluble boron is over 1200 ppm and failed in EN71 Part 3 toy regulation);

### 3) Others.

Wherein, the “others” in C is glycerin and corn flour. In some embodiments, it may be 1-20 wt % glycerin and 1-20 wt % corn flour.

D) Ingredient wt % of low density putty
1) Density reduce filler 2-6%;

### 2) Silicone oil 60-90%;

### 3) Glycerin 2-5%;

4) Boron content 1.2-4% (soluble boron is over 1200 ppm and failed in EN71 Part 3 toy regulation);

### 5) Others.

Wherein, the “others” in D is corn flour. In some embodiments, it may be 1-20 wt % corn flour.

E) Ingredient % of thermoplastic moulding clay 1 (oil soluble)
1) Less than 4% density reduce filler;

### 2) Silicone oil 40-60%;

### 3) Thermoplastic 40-50%;

4) Boron content 0.6-0.8% (soluble boron is less than 1200 ppm and PASS in EN71 to Part 3 toy regulation);

### 5) Others.

Wherein, the “others” in E is glycerin and corn flour. In some embodiments, it may be 1-20 wt % glycerin and 1-20 wt % corn flour.

Advantages for thermoplastic moulding clay 1 (oil soluble) are as follows:

1) Melting: silly putty will be melted within 1-3 mins. Silly putty cannot play as play dough for moulding. thermoplastic moulding clay 1 (oil soluble) will not melt for several weeks.
2) Moulding for low density putty and thermoplastic moulding clay 1 (oil soluble) The low density putty is not suitable for moulding. The hardness is too high when high density reduce filler. Children are difficult to play as final product is too hard. The hardness of low density putty can be reduce by adding glycerin or reduce density reduce filler content. But it will become sticky by adding glycerin or it will melt by reducing density reduce filler.
3) Boron content was reduced from 1.2-5% to less than 0.9%. Only thermoplastic moulding clay 1 (oil soluble) can PASS in EN71 Part 3 toy regulation.

The embodiments described above merely present several embodiments of the present invention, which are described in detail, but should not be interpreted as limiting the scope of the present invention. It should be noted that those skilled in the art could make various modifications and improvements without departing from the concept of the present disclosure, all of which fall within the protection scope thereof. Therefore, the protection scope of the present patent shall be defined only by the appended claims.

What is claimed is:

1. A material composition, comprising:
i) hydroxyl-termination polymer cross-linked by a boron compound; and
ii) thermoplastic having melting point below 100° C.

2. The material composition of claim 1, wherein the thermoplastic is polycaprolactone.

3. The material composition of claim 1, wherein a weight ratio of thermoplastic to the material composition is 1-60%.

4. The material composition of claim 1, wherein a weight ratio of thermoplastic to to the material composition is 5-60%.

5. The material composition of claim 1, wherein the material composition further comprising 1-10% weight percent density reducing filter.

6. The material composition of claim 1, wherein the material composition is water soluble, and a weight ratio of boron to the material composition is less than 0.1%. 7. The material composition of claim 1, wherein the material composition is oil soluble, and a weight ratio of boron to the material composition is 0.6-0.8%.

8. A method of producing the material composition of claims 1, comprising:
supplying component i) hydroxyl-termination polymer cross-linked by a boron compound and component ii) thermoplastic to the mixer;
mixing component i) and component ii) to get the mixture.

9. The method of claim 8, wherein the method further comprising:
adding density reducing filter into the mixer and mixing it with the mixture at room temperature.
